(19) United States
(12) Patent Application Publication
(10) Pub. No.: US 2023/0244957 A1
(43) Pub. Date: Aug. 3, 2023

(54) MACHINE LEARNING MODEL MANAGEMENT USING EDGE CONCEPT DRIFT DURATION PREDICTION

(71) Applicant: Dell Products L.P., Round Rock, TX (US)

(72) Inventors: Vinicius Gottin, Rio de Janeiro (BR); Jaumir Valenca Da Silveira, JR., Rio de Janeiro (BR); Eduardo Vera Sousa, Niterói (BR)

(73) Assignee: Dell Products L.P., Round Rock, TX (US)

(21) Appl. No.: 17/587,628

(22) Filed: Jan. 28, 2022

(51) Int. Cl. G06N 5/02

(52) U.S. Cl. CPC G06N 5/022

(57) ABSTRACT

Techniques are disclosed for machine learning model management using edge concept drift duration prediction. For example, a system can include at least one processing device including a processor coupled to a memory, the at least one processing device being configured to implement the following steps: detecting a drift period in a dataset, the drift period including a start time, wherein the dataset pertains to a machine learning (ML)-based model; determining a first confidence value for a period preceding the start time and a second confidence value for a period following the start time; and predicting a drift period duration for the dataset using an ML-based drift model that is trained based on the first and second confidence values.

### FIELD

Embodiments of the present invention generally relate to machine learning model management. More specifically, at least some embodiments relate to systems, hardware, software, computer-readable media, and methods for managing machine learning models for nodes in an edge environment.

### BACKGROUND

The emergence of edge computing highlights benefits of machine learning model management at the edge. The decentralization of latency-sensitive application workloads increases the benefits of efficient management and deployment of these models. Efficient management implies, beyond model training and deployment, keeping the models coherent with the statistic distribution of input data of all edge nodes. In edge-to-cloud environments, the training of models may be performed at both powerful edge nodes as well as at the cloud. The associated model inference, however, will typically be performed at the edge, due to latency constraints of time-sensitive applications. Therefore, models can benefit from efficient model management configured to consider edge nodes' opinions about model performance.

### SUMMARY

In one embodiment, a system comprises at least one processing device including a processor coupled to a memory, the at least one processing device being configured to implement the following steps: detecting a drift period in a dataset, the drift period including a start time, wherein the dataset pertains to a machine learning (ML)-based model; determining a first confidence value for a period preceding the start time and a second confidence value for a period following the start time; and predicting a drift period duration for the dataset using an ML-based drift model that is trained based on the first and second confidence values.

In some embodiments, the first or second confidence value can be determined for each class predicted by the ML-based model. In addition, the dataset can include a plurality of samples collected from a plurality of data streams received by a plurality of nodes, and the detecting the drift period can further include determining whether a confidence score for one or more samples among the plurality of samples exceeds a predetermined threshold. In addition, the detecting the drift period can further include determining an end time for the drift period; and determining whether the confidence score for the one or more samples exceeds the predetermined threshold at any time between the start time and the end time. In addition, the period preceding the start time can be determined based on a measure of time associated with collecting a quantity of samples contained in the preceding period. In addition, the period preceding the start time can correspond to a measure of time associated with training and deploying an updated version of the ML-based model to a node. In addition, the ML-based model or the drift model can be a classifier model or a regression model. In addition, the period preceding the start time can immediately precede the start time. In addition, the period following the start time can immediately follow the start time. In addition, the period following the start time can be shorter than the drift period duration.

Other example embodiments include, without limitation, apparatus, systems, methods, and computer program products comprising processor-readable storage media.

Other aspects of the invention will be apparent from the following description and the appended claims.

### BRIEF DESCRIPTION OF THE DRAWINGS

The foregoing summary, as well as the following detailed description of exemplary embodiments, will be better understood when read in conjunction with the appended drawings. For purposes of illustrating the invention, the drawings illustrate embodiments that are presently preferred. It will be appreciated, however, that the invention is not limited to the precise arrangements and instrumentalities shown.

In the drawings:

FIG. 1 illustrates aspects of a model coordination system in accordance with example embodiments;

FIG. 2 illustrates aspects of example datasets in accordance with example embodiments;

FIG. 3 illustrates aspects of an example dataset in accordance with example embodiments;

FIGS. 4-6 illustrate aspects of an example confidence determination in accordance with example embodiments;

FIG. 7 illustrates aspects of an example drift model in accordance with example embodiments;

FIGS. 8-9 illustrate aspects of methods for predicting a drift period duration in accordance with example embodiments; and

FIG. 10 illustrates aspects of a computing device or computing system in accordance with example embodiments.

### DETAILED DESCRIPTION

Embodiments of the present invention generally relate to machine learning model management. More specifically, at least some embodiments relate to systems, hardware, software, computer-readable media, and methods for managing machine learning models for nodes in an edge environment.

Disclosed herein are techniques for edge-side drift detection in which aspects of drift period frequency and drift period duration can be used to support model management decision making. For example, conventional edge-side drift detection mechanisms can be enhanced to leverage aspects of drift period frequency and drift period duration for decision making. Advantageously, the disclosed techniques can help inform whether observed concept drift by a machine learning model deployed at the edge or near edge is frequent, cyclical, or lasting enough so as to warrant the retraining of a new model.

In edge-to-cloud management systems, the training of models may typically take place on powerful edge nodes or in the cloud. Model inference, however, can preferentially be performed at the edge due to latency constraints of time-sensitive applications.

Efficient model management at the edge benefits from keeping the deployed models updated, e.g., coherent with the statistical distribution of input data of all edge nodes. Such model management can be accomplished by, for example, drift detection approaches that help determine whether a given model is sufficiently coherent or instead exhibits undesirable drift.

Example technical problems associated with model management at edge nodes can include the following:
Heterogeneity of compute power and network costs,
Need for labeled data at inference time in edge devices, and
Temporal aspects of drift detection

Regarding heterogeneity, many issues that arise for model management task at the edge are related to the need for dealing with heterogeneity and the unreliability intrinsic to the environment. The deployment of models and the relevant management tasks, among them drift detection, must be transparent to the number of edge nodes, and also be able to deal with varying levels of compute power. As such, these tasks are typically carried out at the cloud, avoiding the management overhead but incurring heavy network burden. Asynchronous deployment and management of models is desirable to alleviate the management overhead. Performing management tasks such as drift detection at the edge is also desirable, for minimizing said network costs.

Regarding an inference-time need for labeled data at the edge, conventional drift detection and mitigation techniques presume access to model performance over time, which in turn means that labels are necessary for drift detection. Model management techniques also monitor model performance over time, with also the assumption of collecting all or a subsample of labels at inference time.

Regarding temporal aspects of drift detection, domain and context clues can be relevant to drift detection, including aspects of drift duration and drift frequency. More generally, these temporal aspects relate to a concern of model management: determining when it is necessary to retrain a model. Frequency is also related to temporal patterns of repetition, for example, when one or more edge nodes perform in two or more alternating ‘modes,’ then a model trained for one of those modes would always appear to suffer from concept drift as the other mode(s) occur.

Example embodiments provide technical solutions to the technical problems articulated above. Example embodiments are configured to perform drift detection over models in an edge computing environment. More specifically, example embodiments are configured for edge-side drift detection considering temporal aspects, so as to improve decision making (especially regarding re-training and redeployment of models) in model management tasks.

Example embodiments are configured to perform edge-side unsupervised concept drift detection with drift frequency and drift duration evaluation for decision making. The approach described herein enhances conventional drift detection approaches to allow reasoning about duration of concept drift periods. The technical solutions herein can be applicable in two stages, e.g., one offline stage, related to the training and deployment of a model that predicts duration of drift periods, and one online stage, in which the model is leveraged to evaluate how long detected drift will last, and enable decision-making based on that evaluation. Analysis of drift period duration (and severity/magnitude of drift) can help to avoid redeploying a model in response to a temporary drift. Analysis of drift period frequency can help avoid spurious cyclic and repeated retraining and redeployment.

Specific embodiments of the invention will now be described in detail with reference to the accompanying figures. In the following detailed description of example embodiments, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

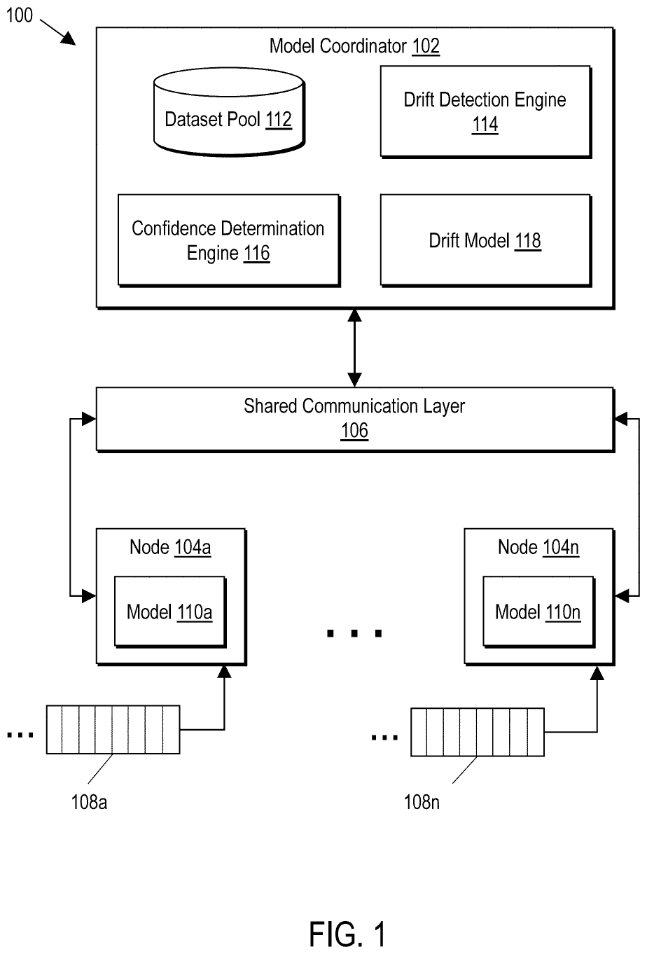

In the following description of FIGS. 1-10, any component described with regard to a figure, in various embodiments of the invention, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment which may be implemented in addition to, in conjunction with, or in place of the embodiments described with regard to a corresponding like-named component in any other figure.

Throughout the application, ordinal numbers (e.g., first, second, third, etc.) may be used as an adjective for an element (i.e., any noun in the application). The use of ordinal numbers is not to necessarily imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and a first element may encompass more than one element and succeed (or precede) the second element in an ordering of elements.

Throughout this application, elements of figures may be labeled as “a” to “n”. As used herein, the aforementioned labeling means that the element may include any number of items and does not require that the element include the same number of elements as any other item labeled as “a” to “n.” For example, a data structure may include a first element labeled as “a” and a second element labeled as “n.”. This labeling convention means that the data structure may include any number of the elements. A second data structure, also labeled as “a” to “n,” may also include any number of elements. The number of elements of the first data structure and the number of elements of the second data structure may be the same or different.

FIG. 1 shows aspects of a model coordination system in accordance with example embodiments. FIG. 1 illustrates a model coordination system 100 including a model coordinator 102 in communication with nodes 104a, . . . , 104n using a shared communication layer 106. The model coordinator, nodes, and shared communication layer are configured to coordinate management of machine-learning-based models.

In example embodiments, each node 104a, . . . , 104n (sometimes collectively referred to herein as the nodes 104 or a node 104) may comprise an edge computing node. The node 104 may be configured to capture a data stream 108a, . . . , 108n (sometimes collectively referred to herein as the data streams 108 or a data stream 108). In some embodiments, the data stream may be continuous or, in other embodiments, sporadic. In example embodiments, the data stream 108 may be obtained by sensors associated at or with that respective node. In some embodiments, the node may store the captured data locally at the node, for a variable period of time, for example in a local data pool (Lᵢ).

In example embodiments, each node 104 may be configured to store and use multiple machine learning (ML)-based models. For purposes of illustration, the present disclosure discusses and represents a single model 110a, . . . , 110n (sometimes referred to collectively as the models 110 or a model 110) for a particular task at each node 104a, . . . , 104n, e.g., models M⁰, M¹, . . . . Some embodiments can benefit from a homogeneous edge environment with respect to the data streams 108. For example, some embodiments of the present system can benefit when the data streams S₀, S₁, . . . , Sᵢ, . . . generally conform to a same underlying distribution at a given time. Advantageously, distribution changes detected in connection with one stream (which can possibly be characterized as drift) can be expected to be perceived in connection with all other streams at substantially the same time, albeit possibly with some delay. Thus, example embodiments of the present system can be configured to enact or trigger “updates” of all the models of all nodes 104 in response to drift detected or perceived in any or all of the data streams, depending on domain-dependent decision making.

In example embodiments, the shared communication layer 106 can be an object through which communication is performed between the model coordinator 102 and the nodes 104. In some embodiments, the shared communication layer can be a software object that facilitates communication between the model coordinator and the nodes, for example, in an indirect and asynchronous fashion. In some embodiments, the shared communication layer can include a storage area in which messages and data can be stored and discarded. In some embodiments, the shared communication layer is configured to manage this storage area by, for example:
accepting and executing requests for storing, updating, and deleting messages in the storage area;
accepting and executing requests to store published models by the model coordinator to be consumed by the nodes; and
accepting and executing requests to store data sample batches from the nodes to be used for retraining by the model coordinator.

As used herein, messages refer to specific short sequences of bytes that signal system states that are understood by both the model coordinator 102 and the nodes 104. In example embodiments, advantageously the design of the shared communication layer 106 as a middle software layer that is used by the model coordinator and the nodes to communicate provides a benefit of asynchronism and independence of implementation between the model coordinator and the nodes. To the extent that the present disclosure refer to communications such as the model coordinator “sends a signal” to the nodes, or the nodes “signal” the model coordinator, it should be understood that such example signals refer to messages sent by the emitter (e.g., the model coordinator or the node acting as a source) to the shared communication layer and received by the receiver(s) (e.g., the model coordinator or the node acting as a target) by polling the shared communication layer at given times and situations according to the model management techniques discussed in further detail herein.

In example embodiments, the model coordinator 102 can be provided at a central node. In some embodiments, the central node may be a cloud service having elastic computational resources, or a pool of static computational resources. The model coordinator can be deployed in, for example, an edge computing environment such as an edge-cloud or an edge-core configuration. The model coordinator includes a dataset pool 112, a drift detection engine 114, a confidence determination engine 116, and a drift model 118. The model coordinator is configured for model management and mechanism for edge-side drift detection. Advantageously, the mechanism described herein is confidence-based and unsupervised, e.g., the disclosed techniques do not require the true labels of the associated data to detect drift. Example embodiments of the system 100 support two stages. The first stage takes place at training time, and the second stage at inference time. In some embodiments, the inference stage is operable substantially on the edge.

In example embodiments, the dataset pool 112 is configured to store historical data representative of the domains of activity of the nodes 104. The historical data can include, for example, samples collected from the streams 108 received by the nodes 104. The samples and historical data can be used to determine associated confidence scores and confidence values, detect drift and drift periods, and predict drift period duration, as described in further detail below.

In example embodiments, in a training stage the confidence determination engine 116 of the model coordinator 102 can be configured to inspect and collect confidence levels in inferences by the model 110 over the training set. In some embodiments, after the model is trained, the training set can be used again to obtain values of a softmax layer for each sample. The aggregated values of the softmax layer of the sample set can represent confidence levels, e.g., measures of the quality or correctness of inferences made by the model.

In example embodiments, the confidence determination engine 116 can be configured to determine a confidence score (γ) that assesses or evaluates an individual inference (e.g., the class with higher probability) of a sample. An example classification problem is discussed throughout the present disclosure involving image classification of handwritten digits based on the Modified National Institute of Standards and Technology database (e.g., the MNIST classification problem), for purposes of illustration. The example embodiments disclosed herein, however, are more generally applicable to models and classification problems, without departing from the scope of the invention.

Example embodiments of the confidence determination engine can be configured to determine an aggregate confidence statistic (μ), sometimes also referred to herein as a confidence value or an inference confidence value. The confidence value can represent an aggregate statistic (μ) of the confidence over the complete training dataset, which in example embodiments can be updated accordingly by the confidence determination engine. In some embodiments, the aggregate statistic can include a mean (e.g., average) prediction confidence of all inferences. Other statistics can also be used as appropriate for the corresponding domain without departing from the scope of the invention.

Determining and using confidence scores (γ) and confidence values (μ) can be carried out, for example, using components and models such as detailed in connection with FIG. 1, and/or using one or more of the techniques disclosed in U.S. patent application Ser. No. 17/363,235, filed Jun. 30, 2021 and entitled “Asynchronous Edge-Cloud Machine Learning Model Management With Unsupervised Drift Detection,” the contents of which are incorporated by reference herein in their entirety for all purposes.

In some embodiments, the mean may be updated on a sample-by-sample basis if the number of samples already considered (k) is kept in memory and incremented accordingly. For example, for each sample,

$$μ ← μ + \frac{γ}{k}$$

and k←k+1 when k>0; and μ←γ otherwise.

In example embodiments, in the training stage the confidence determination engine 116 may be configured to obtain the confidence for each sample and update an aggregate statistic in an online phase or an offline phase. As used herein, the online phase with respect to training refers to performing the disclosed processing as batches of samples are processed. The offline phase with respect to training refers to performing the disclosed processing after a resulting model is obtained. In some embodiments, advantageously, the confidence determination engine may be configured to consider only those confidence levels in inferences that are determined to be correct (e.g., inferences that result in the prediction of the true label for the given sample). In either case, and especially during the offline phase since the model is already converged, if the overall error of the model is determined to be very small, this may not significantly impact the aggregated statistic (μ). However, for models exhibiting lower accuracy, considering only true predictions can result in a significantly higher value for the inference confidences (i.e., the model is more likely to assign higher confidences to inferences of easier cases, that the model is able to correctly classify or predict).

In example embodiments, the resulting aggregate statistics (μ) can be used to derive a confidence threshold (t) for the model. This threshold can represent an aggregate confidence of the model on the inferences that the model performed on the training dataset. In some embodiments, such as where the aggregate statistic is the mean of the confidence of the samples, the threshold may be predetermined as a fraction (or factor) of the mean; or the mean adjusted by a constant factor. The threshold can be, for example, 0.9 of the mean of the confidence of the inference over the training samples, although other predetermined values can be used without departing from the scope of the invention.

In example embodiments, the resulting threshold (t) can be propagated to the nodes 104 for use during the edge-side inference stage. Although the previous discussion has generally referred to a neural network classification model for purposes of illustration, the same methodology can be applied to regression neural networks, for example, by using variational neural networks and using a standard deviation of the prediction as the confidence of a sample. In some embodiments, the threshold (t) can be adjusted downward so that the confidence determination engine 116 is able to avoid excessive false positives, as discussed in further detail below.

In example embodiments, during the inference stage the drift detection engine 114 of the model coordinator 102 is operable, for example for each node 104. For example, the drift detection engine can be configured to inspect the model 110 in a similar way as described previously in connection with the training stage.

In example embodiments, at an edge controller in communication with the node, a batch (B) of samples can be composed from the local data (Lⁱ) that corresponds to samples from the local stream 108 (Sᵢ) collected by the node. The batch (B) can be provided as input to the model 110 (Mⁱ) for inference. The results R={r₀, . . . , r_{|B|}} and Γ={γ₀, . . . , γ_{|B|}} can also be stored. These results can comprise the results (rⱼ) used for each sample (j) in B (e.g., the predicted classes) along with the corresponding inference confidence score of the model in that result (yⱼ) (e.g., the confidence score of the model in the predicted class).

In example embodiments, during the inference stage the inference confidence scores (γ) of each sample can be obtained in a similar way as the method used to obtain the confidence scores during the training stage, as described previously. Also, in a similar way as during the training stage, the respective confidence scores can be aggregated into a representative statistic (μ).

In example embodiments, during the inference stage the drift detection engine 114 can be configured to compare the aggregated inference confidence (μ) for all samples in the batch (B) to the threshold value (t) obtained from the training stage. If μ<t, the drift detection engine can be configured to determine that a drift has occurred (e.g., the model is less confident in its predictions for the batch (B)). Otherwise (e.g., when μ≥t) the drift detection engine can be configured to conclude that no drift has occurred (e.g., the model has more confidence in its predictions for the batch (B)).

In example embodiments, the model coordinator 102 reflects an intuition that, if the model 110 is sufficiently confident in its predictions, at least to a similar level as in the training stage, then the distributions of the stream data 108 at the nodes 104 are likely to be similar to those of the training data. It will be understood that this confidence generally represents a reasonable heuristic, though it is acknowledged that it is not an immutable guarantee. Conversely, where the model 110 may not be sufficiently confident in its predictions, then this scenario can likewise be a reasonable heuristic representing concept drift in the stream data.

Advantageously, it will also be noted in connection with the previous disclosure that no label is required since the inference confidence is what is being inspected in the model 110 itself. This is another motivation for why the threshold (t) can be expected to be a value lower than the aggregate statistic (μ) (e.g., the average) found at training time. If the threshold t is high, then a batch of difficult (e.g., relatively ‘hard’) samples will indicate a drift, which is undesirable. Instead, by leveraging a lower threshold (t), the present system is configured to process a drift only when a batch presents a significantly lower confidence than the global confidence experienced by the model during training.

In example embodiments, the drift model 118 of the model coordinator 102 is configured to predict a drift period duration for samples in the data stream 108 based on various confidence values. The drift model is trainable based on detected drift periods in the data streams, as discussed in further detail herein.

It is to be understood that the particular set of elements shown in FIG. 1 for model management techniques involving the nodes 104 and the model coordinator 102 of the present model coordination system 100 is presented by way of illustrative example only, and in other embodiments additional or alternative elements may be used. Thus, another embodiment includes additional or alternative systems, devices, and other network entities, as well as different arrangements of modules and other components. For example, in at least one embodiment, the model coordinator 102 and the dataset pool 112 can be on and/or part of distinct processing platforms.

It is to be appreciated that this particular arrangement of modules 112, 114, 116, 118 illustrated in the model coordinator 102 of the FIG. 1 embodiment is presented by way of example only, and alternative arrangements can be used in other embodiments. For example, the functionality associated with modules 112, 114, 116, 118 in other embodiments can be combined into a single module, or separated across a larger number of modules. As another example, multiple distinct processors and/or memory elements can be used to implement different ones of modules 112, 114, 116, 118 or portions thereof. At least portions of modules 112, 114, 116, 118 may be implemented at least in part in the form of software that is stored in memory and executed by a processor.

It is also to be appreciated that a “model,” as used herein, refers to an electronic digitally stored set of executable instructions and data values, associated with one another, which are capable of receiving and responding to a programmatic or other digital call, invocation, and/or request for resolution based upon specified input values, to yield one or more output values that can serve as the basis of computer-implemented recommendations, output data displays, machine control, etc. Persons of skill in the field may find it convenient to express models using mathematical equations, but that form of expression does not confine the model(s) disclosed herein to abstract concepts; instead, each model herein has a practical application in a processing device in the form of stored executable instructions and data that implement the model using the processing device.

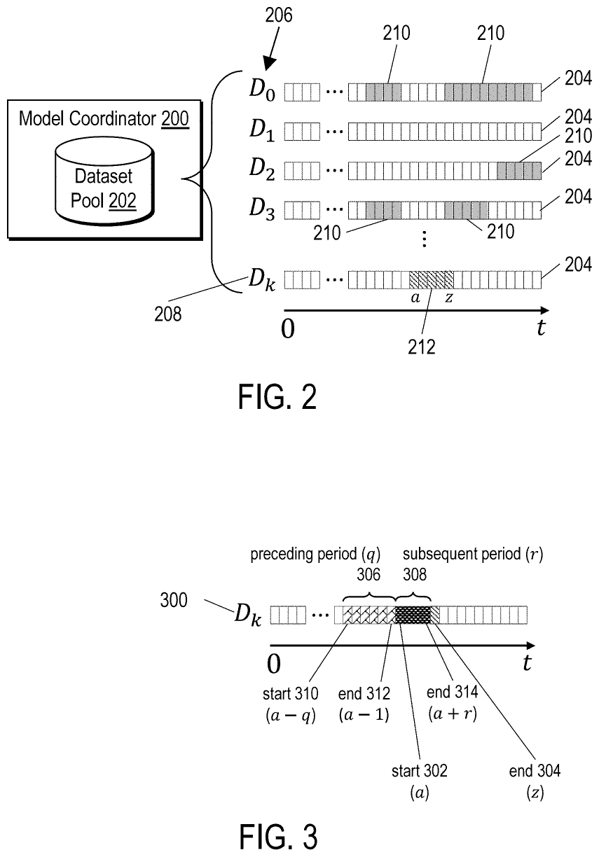

FIG. 2 shows aspects of example datasets in accordance with example embodiments. FIG. 2 illustrates example datasets 206 stored by a model coordinator 200 (an example of the model coordinator 102 (FIG. 1)) using a dataset pool 202 (an example of the dataset pool 112 (FIG. 1)).

In example embodiments, in an offline stage of the model coordinator 200, the present system is configured to process one or more labeled datasets 206 (D) where each dataset includes samples dₜ collected from data streams 204. In some embodiments, each dataset D is associated with (e.g., originates from) an edge node's stream (such as, e.g., the streams 108 (5₀, S₁, . . . ) (FIG. 1)). The historical dataset stored in the dataset pool 202 of the model coordinator 200 can thus include the set 206 of datasets D available. In some embodiments, each dataset D is ordered by time of collection (t), such that a given sample (dₜ) precedes a subsequent sample (dₜ₊₁), for any 0≤t≤z. In some embodiments, the present system is configured to process each dataset 206 Dᵢ as if the dataset starts at time t=0 individually (e.g., the oldest sample in each dataset Dᵢ can be assigned a timestamp of zero) even if the datasets are unaligned, e.g., based on their collection time at the node. Advantageously, the present system is capable of processing datasets that may be missing samples for a given timestamp, or datasets containing more than one sample for a given timestamp. For purposes of illustration, the model coordination techniques disclosed herein discuss example processing of datastreams that are presumed to have available samples for every timestamp, and exactly one sample for each timestamp. It will be appreciated, however, that the scope of the invention is not so limited and the present disclosure addresses processing of missing or overlapping samples where applicable.

In example embodiments, each sample in d ∈ D pertains to a class in the set of classes [symbol] ={C⁰, C¹, . . . , C^{z}} considered by the domain. The present system is configured to obtain a model (M) (in some embodiments, a classifier model) that considers that set of classes. The model is deployed to the edge nodes in the domain. The model (M) can be obtained via any conventional machine learning process. The present system is configured to leverage a similar training approach as described previously in connection with FIG. 1, where the dataset 206 (D) comprises part of the training data for the model.

In example embodiments, the present system is configured to leverage an obtained inference confidence score (y) for a given sample (d) by the ML-based model (M). In example embodiments, the present system is further configured to leverage any available approach for drift detection at the edge nodes. Advantageously, the drift detection approach described previously in connection with FIG. 1 satisfies both these aspects, as discussed in further detail below. A corresponding example approach for model management is also discussed accordingly in further detail below:

In example embodiments, for a labeled dataset Dᵢ, the present system is configured to identify periods of concept drift, such as the example drift periods 210 for the example datasets 206. A sample drift period 212 for an example dataset 208 Dₖ is illustrated including a start time (a) and an end time (z). This drift period identification may use any underlying approach for drift detection. As used herein, the notation [a, z] refers to a period of time (e.g., a drift period duration) between and including a and z.

Although the present disclosure discusses an example representation of a very small number of samples 204 for purposes of illustration, it will be appreciated that in actual environments the datasets 206 may comprise large numbers of samples (e.g., hundreds, thousands, tens or hundreds of thousands, millions, or billions of samples or the like).

In example embodiments, [symbol] can refer to a set of tuples (a, z) where each tuple determines a starting time a and an ending time z of a drift period 210, thereby also defining a drift period duration s=z −a. Advantageously, each sample 204 dₜ∈ D can be determined as belonging to a drift period simply by checking whether t falls within an identified period of concept drift [a, z]. Example embodiments of the present model coordination system are configured to leverage this computational efficiency, as discussed in further detail below.

In some embodiments, a few simplifying observations may be made in connection with determining periods of concept drift. First, ‘open ended’ drift periods may be omitted from processing and not considered. For example, the example dataset 206 D₂ (presumed to originate from the stream S₂) is illustrated as currently under drift at timestamp t. In some embodiments since an end timestamp z cannot yet be determined, the present system is configured to disregard that drift period in the model management processing.

In example embodiments, as discussed earlier, missing samples 204 for certain timestamps may occur particularly during drift periods 210. In some embodiments, for example, upon identifying drift, edge nodes may reduce the sampling interval and the interval in which the edge nodes apply their model for inference (e.g., to improve performance at the edge or near edge). In some embodiments, the present system presumes that the first sample after a drift period can be leveraged as an indicator that the previous sample represents an end (z) of the drift period. Advantageously, this design decision can underestimate the determined duration (s) of drift periods. It will be appreciated that additional approaches to determining drift periods in response to missing samples may be implemented with little effect on the overall approach and without departing from the scope of the invention.

FIG. 3 shows aspects of an example dataset in accordance with example embodiments. FIG. 3 illustrates an example dataset 300 (Dₖ) with an example drift period having start time 302 (a) and end time 304 (z).

In example embodiments, the present system is configured to leverage drift detection methods that collect inference confidence scores (γ) for each sample in the training dataset. For example, advantageously, if the inference confidence scores are already obtained as part of the concept drift period detection (for example, using the approaches described previously in connection with FIG. 1), then the inference confidence scores can be reused, as described in further detail herein.

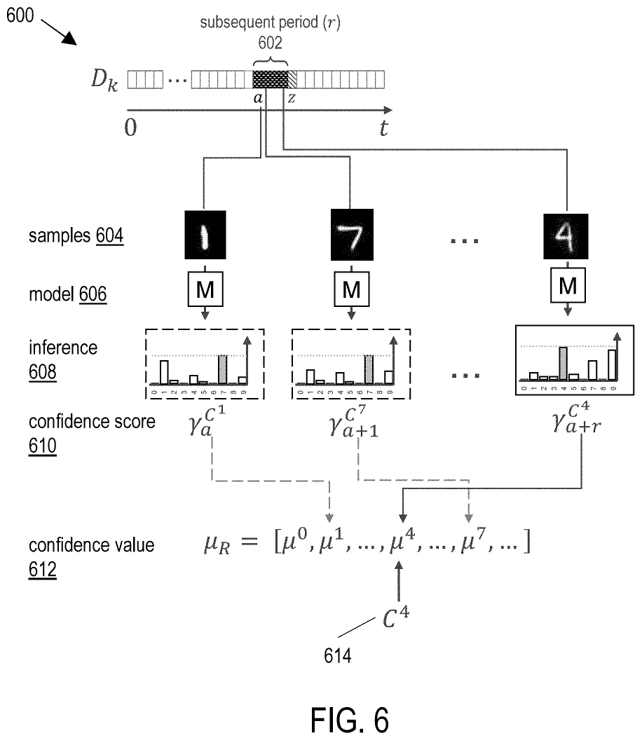

In example embodiments, the present system is configured to leverage a preceding period 306 (q) of time prior to the start time 302. The preceding period can have a start time 310 (a−q) and an end time 312 (a−1). In some embodiments, the present system is further configured to leverage a subsequent period 308 of time (r) following the start time, as discussed in further detail below in connection with FIG. 6. The subsequent period can have a start time 302 (a) and an end time 314 (a+r).

In example embodiments, to leverage the preceding period 306 (q), the present system is configured to obtain the inference confidence scores for the samples during the preceding period 306 [a−q, a]. As used herein, q can refer to a parameter representing the maximum number of samples preceding a drift period to be processed. Put another way, these samples can comprise a set D_{q}={dₜ|t<aΛt≥(a−q)}. FIG. 3 illustrates an example preceding period 306 (q) immediately preceding an example drift period for an example dataset 300 (Dₖ). The drift period has an example start time 302 (a) and an example end time 304 (z).

In example embodiments, the preceding period parameter (q) can be determined based on the amount of time to collect a quantity of samples contained in the preceding period 306. In some embodiments, the preceding period parameter (q) can correspond to a duration or length of time determined to be sufficient for training and deploying a new version of the model (M) to the edge node.

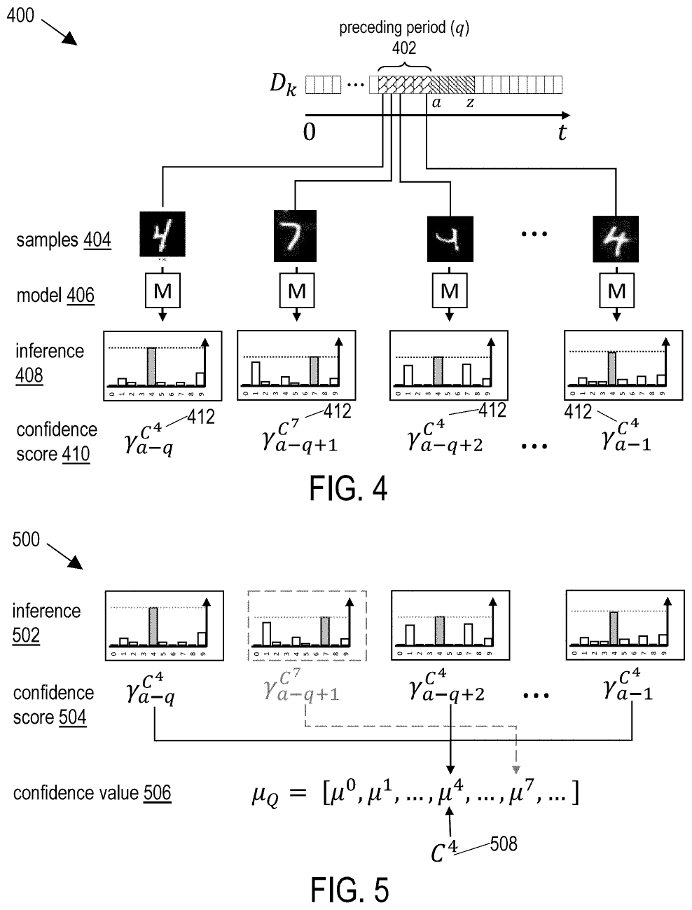

FIG. 4 shows aspects of an example confidence determination in accordance with example embodiments. FIG. 4 illustrates an example approach 400 for determining an example confidence score 410 (γ) based on example inferences 408 associated with a model 406 (M) (an example of the model 110 (FIG. 1)) when processing example samples 404 (examples of the samples 108 (FIG. 1)). Advantageously, in example embodiments the confidence score can be associated with a given class 412 (Cⁱ).

In some embodiments, for each sample d_{q} ∈ D_{q} associated with a preceding period 402 (q), the present system is configured to obtain an inference confidence score 410 (γₜ^{C}^{ⁱ}) for the predicted class(es) 412 (Cᵢ) by the model 406 (M). In some embodiments, this is why the drift detection approach described previously in connection with FIG. 1 can be beneficial, since it naturally provides the inference confidence scores of the samples. In other embodiments, if other drift detection approaches are used to determine the associated drift period(s) [a, z] ∈ [symbol] , then the present system is configured to obtain the inference confidence score of d_{q} in other ways, for example by recomputing the inference confidence score from the beginning (e.g., by performing an inference and capturing intermediate information within the model 406).

FIG. 4 illustrates an example determination of an inference confidence score 410 in accordance with the approach described above. More specifically, inference confidence scores (γₜ^{C}^{ⁱ}) are illustrated for predicted classes from samples in the preceding period [a−q, a] of a dataset. Illustrated are three examples for a predicted class C⁴ (e.g., at times t=a−q, a−q+2, and a−1, and corresponding to the class of digit ‘4’ in the dataset as shown in the inferences 408) and one example for a predicted class C⁷ (e.g., at time t=a−q+1 and corresponding to the class of digit ‘7’ in the dataset).

FIG. 5 shows aspects of an example confidence determination in accordance with example embodiments. FIG. 5 illustrates an example approach 500 for determining an example confidence value 506 (μ) based on example confidence scores 504 (γₜ^{C}^{ⁱ}) associated with an example inference 502. Advantageously, the confidence value can be associated with a given class 508 (Cⁱ).

In example embodiments, the confidence value 506 (μ) for the preceding period (q) results from determining, for example, an aggregate statistic of the inference confidence scores 504 (γₜ^{C}^{ⁱ}) for all correctly classified samples in D_{q}. Advantageously, in some embodiments these statistics can be aggregated based on the inferred class >={C⁰, C¹, . . . , C^{z}}. In some embodiments the aggregate statistic may be the mean. Other applicable statistics may also be adopted without departing from the scope of the invention. These statistics are sometimes referred to herein as μ_{Q}. This notation is somewhat simplified for purposes of illustration, e.g., assuming that the discussion focuses on a particular drift period 402 (FIG. 4) (with the acknowledgment that a complete notation might further include, for example, an index for the dataset, an index of the drift period in the set P, as well as in that dataset).

Referring back to FIG. 4, only a few samples 404 of predicted digit ‘4’ and one sample 404 of a predicted digit ‘7’ in the period 402 [a−q, a] preceding the drift are illustrated, for purposes of illustration due to the restricted size of the illustrated example. In some embodiments, the confidence scores are labelled with the associated timestamp (acknowledged to be a simplified notation in reliance on the fact that the example presumes a single drift period (q) for purposes of illustration). Accordingly, it will be appreciated that in actual environments (e.g., live or production) this drift period could comprise many (e.g., potentially many thousands of) samples and accordingly each predicted class could relate to many inference confidence scores.

Referring back to FIG. 5, an example confidence value 506 (μ_{Q}) is shown representing aggregate statistics in connection with the example drift period 402 (q) (FIG. 4). FIG. 5 illustrates an example determination of the aggregate confidence value (in some embodiments, a median) for the inference confidence scores 504 of the predicted class 508 (C⁴). Advantageously, in example embodiments the confidence value (μ_{Q}) can be determined per class, such as for the predicted class 508 (e.g., C⁴).

FIG. 6 shows aspects of an example confidence determination in accordance with example embodiments. FIG. 6 illustrates an example approach 600 for determining an example confidence value 612 (μ_{R}) based on example inferences 608 associated with a model 606 (M) (an example of the model 110 (FIG. 1)) when processing samples 604 (examples of the samples 108 (FIG. 1)). Advantageously, in example embodiments the confidence value can be associated with a given class 614 (Cⁱ).

In example embodiments, the present system is configured to determine a confidence value 612 (μ_{R}). The confidence value can be an aggregate statistic(s) based on the inference confidence scores 610 for the samples 604 during the immediate start of the drift period 602 [a, a+r] with r<s being a parameter representing the number of samples during the immediate start of the drift period (r) to consider (recalling that s represents the drift period duration). Formally, these samples comprise a set Dᵣ={dᵣ|t≥aΛt≤a+r)} having resulting aggregate statistics μ_{R}. FIG. 6 illustrates an example determination of the confidence value 612 for an associated class 614 (e.g., C⁴).

In some embodiments, the number of samples (r) can be selected to be small, so as to allow for faster determination of a drift period duration, but also large enough to be representative of cases of classes 614 in the domain. Any method for determining an appropriate value for r can be used without departing from the scope of the invention. In the illustrated example it will be appreciated that the represented number of samples determined by r is very small for purposes of illustration.

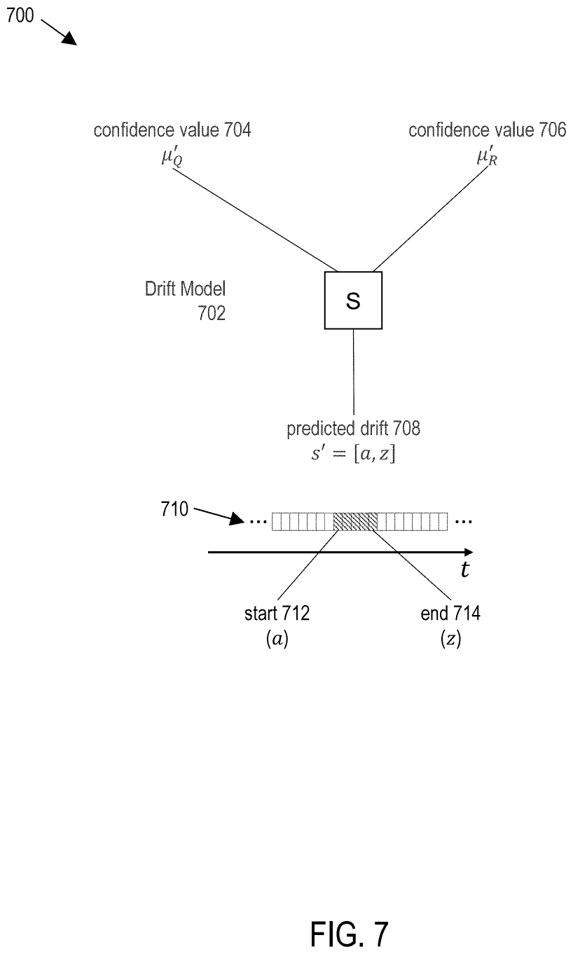

FIG. 7 shows aspects of an example drift model in accordance with example embodiments. More specifically, FIG. 7 illustrates an example approach 700 to predicting a drift period duration using a drift model 702 (an example of the drift model 118 (FIG. 1)).

In example embodiments, the present system is configured to obtain a drift model 702 that is trained based on relating the inference confidence score statistics 704, 706 (examples of the confidence values 506, 612, respectively (FIGS. 5, 6)) for the periods preceding a drift (μ′_{Q}) and following a drift (μ′_{R}), where the drift model is configured to predict an estimate of the duration 708 of the drift period (s′). For example, the illustrated drift period for the data stream with samples 710 has a start time 712 (a) and an end time 714 (z). The drift model is sometimes referred to herein as S, as distinguished from the ML-based model (M) for the domain.

In some embodiments, advantageously, a significant quantity of drift periods may be available (so as to provide sufficient data for a training phase for the drift model 702 (S)), given that the ML-based model (M) can be deployed to an edge environment that includes an appreciably large number of nodes. In embodiments in which each node performs drift detection (e.g., as discussed previously in connection with FIG. 1), a significant number of drift periods may be detected. Advantageously, the present system may have correspondingly many values for (μ_{Q}, μ_{R}, s) available for use. For example, one such triple for each drift period in any dataset may be available.

In example embodiments having a sufficiently large edge environment comprising many edge nodes (e.g., thousands, tens or hundreds of thousands, millions, or the like), the drift model 702 may be a neural network that is trainable with data relating μ′_{Q}, μ′_{R}→s′.

In alternate embodiments, for example if the number of available triples is comparatively smaller, the drift model 702 (S) may comprise a regression model that is trainable to relate a per-class difference between the inference confidence statistics (e.g., μ′_{R}-μ′_{Q}) to the duration 708 of the drift period (s′). This embodiment may also be leveraged in edge environments in which the nodes have limited processing power and storage capability, since the drift model (S) can be deployed to the edge nodes along with the ML-based model (M). Other kinds of models can be applied if applicable, without departing from the scope of the invention.

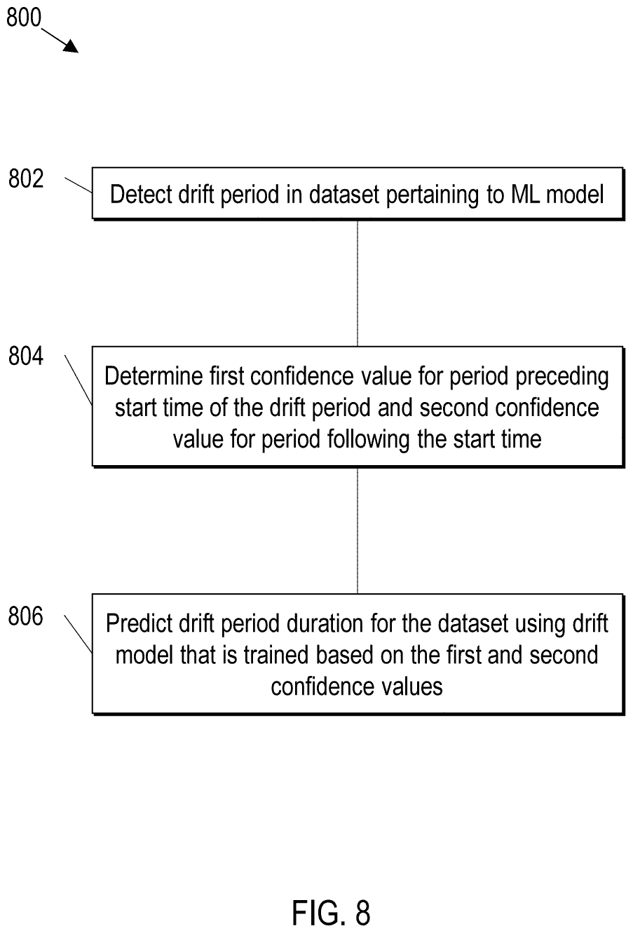

FIG. 8 shows aspects of a method for predicting a drift period duration in accordance with example embodiments.

In this embodiment, the method 800 includes steps 802 through 806. In some embodiments, these steps may be performed by the model coordinator 102 utilizing its elements 112, 114, 116, and 118 (FIG. 1). In some embodiments, these steps may be associated with an offline phase (e.g., relating to training and deployment of a drift model trained to predict duration of drift periods).

In example embodiments, the method 800 includes detecting a drift period in a dataset pertaining to an ML-based model (step 802). The drift period can include a start time. The dataset can include a plurality of samples collected from a plurality of data streams received by a plurality of nodes, for example at the edge. Detecting the drift period can further include determining whether a confidence score for one or more samples among the plurality of samples exceeds a predetermined threshold. Detecting the drift period can further include determining an end time for the drift period, and determining whether the confidence score for the one or more samples exceeds the predetermined threshold at any time between the start time and the end time.

In example embodiments, the method 800 includes determining a first confidence value for a period preceding the start time, and a second confidence value for a period following the start time (step 804). The first or second confidence value can be determined per class predicted by the ML-based model. For example, the first or second confidence value can be determined for each class predicted by the ML-based model. The period preceding the start time can be determined based on a measure of time associated with collecting a quantity of samples contained in the preceding period, such as (a−q+1) samples. The period preceding the start time can correspond to a duration or length of time determined to be sufficient for training and deploying a new version of the model to a node. The period preceding the start time can immediately precede the start time. The period following the start time can immediately follow the start time.

In example embodiments, the method 800 includes predicting a drift period duration for the dataset using a drift model that is trained based on the first and second confidence values (step 806). The ML-based model or the drift model can be a classifier model or a regression model. The period following the start time can be shorter than the drift period duration.

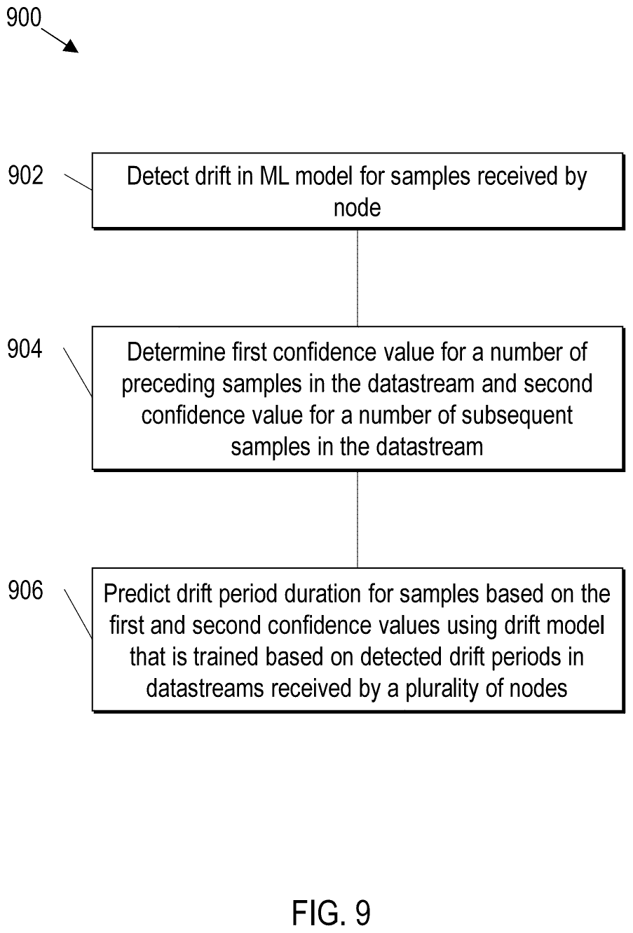

FIG. 9 shows aspects of a method for predicting a drift period duration in accordance with example embodiments.

In this embodiment, the method 900 includes steps 902 through 906. In some embodiments, these steps may be performed by the model coordinator 102 utilizing its elements 112, 114, 116, and 118 (FIG. 1). In some embodiments, these steps may be associated with an online phase (e.g., leveraging the ML-based model deployed at the node to evaluate how long detected drift is predicted to last).

In example embodiments, after the offline stage, the drift model (S) is deployed to the nodes along with the ML-based model (M). As each node consumes new samples from its own data stream and performs inference (e.g., via the ML-based model (M)), an approach for drift detection may be applied (step 902). For example, an approach can be applied similar to determining the confidence scores and confidence values described previously in connection with FIG. 1, such as the edge-side inference stage. Advantageously, the edge-side inference approach is configured to leverage inference confidence scores, which can speed subsequent determinations as described previously. For example, if the drift detection approach already collects such inference confidence scores, the present system can be configured to reuse the confidence scores rather than inspect the confidence scores especially for our method. Other kinds of edge-side drift detection approaches can also be used without departing from the scope of the invention.

In example embodiments, upon identifying a possible drift period, the method 900 includes determining a first confidence value for a number of preceding samples in the node's stream and determining a second confidence value for a number of subsequent samples in the node's stream (step 904). For example, the method can include determining per-class aggregate statistics (4) of the inference confidence scores of the most recent preceding (q) samples in that node's stream. For example, the method can also including gathering next samples in the node's stream, e.g., up to r timestamps, and obtaining the associated inference confidence scores, e.g., via the ML-based model (M). In some embodiments, the associated inference confidence scores may turn out to be unavailable since the ML-based model (M) would be considered drifted and the inference via the ML-based model (M) has not already performed, as was the case for the preceding samples (q) before the drift detection signal. The method can further include determining per-class aggregate statistics μ′_{R} of the inference confidence scores of the next samples in the node's stream.

In example embodiments, the method 900 includes predicting a drift period duration for the samples based on the first and second confidence values using a drift model that is trained based on detected drift periods in datastreams received by a plurality of nodes (step 906). For example, with μ′_{R} and μ′_{Q} available at the node, the present system is configured to determine a predicted drift duration (s′) to the current period of detected drift using the drift model (S). In some embodiments, if the drift model (S) comprises a regression model, then the method can include determining the difference μ′_{R}−μ′_{Q} to provide to the drift model as input.

While the various steps in the example methods 800, 900 have been presented and described sequentially, one of ordinary skill in the art, having the benefit of this disclosure, will appreciate that some or all of the steps may be executed in different orders, that some or all of the steps may be combined or omitted, and/or that some or all of the steps may be executed in parallel.

It is noted with respect to the example methods 800, 900 of FIGS. 8 and 9 that any of the disclosed processes, operations, methods, and/or any portion of any of these, may be performed in response to, as a result of, and/or, based upon, the performance of any preceding process(es), methods, and/or, operations. Correspondingly, performance of one or more processes, for example, may be a predicate or trigger to subsequent performance of one or more additional processes, operations, and/or methods. Thus, for example, the various processes that may make up a method may be linked together or otherwise associated with each other by way of relations such as the examples just noted. Finally, and while it is not required, the individual processes that make up the various example methods disclosed herein are, in some embodiments, performed in the specific sequence recited in those examples. In other embodiments, the individual processes that make up a disclosed method may be performed in a sequence other than the specific sequence recited.

As mentioned previously, at least portions of the model coordination system 100 can be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the system 100. For example, containers can be used to implement respective processing devices providing compute and/or storage services of a cloud-based system. Again, containers may be used in combination with other virtualization infrastructure such as virtual machines implemented using a hypervisor.

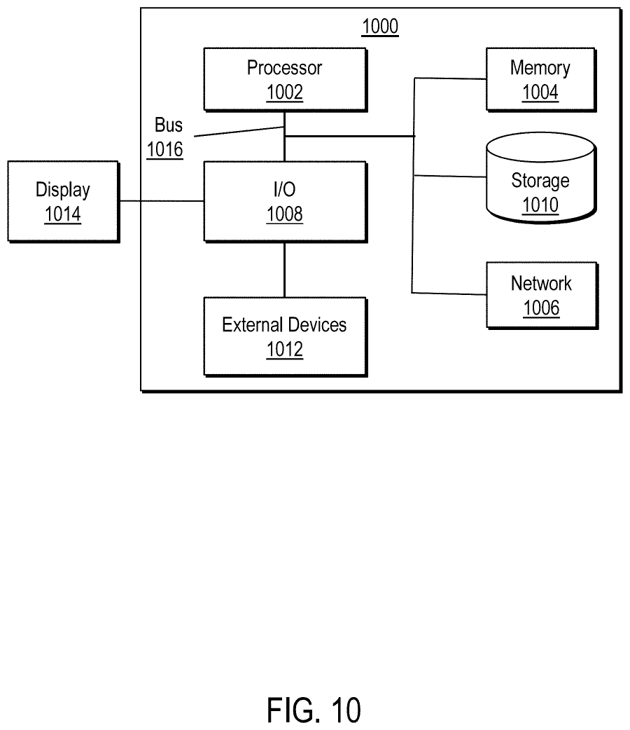

Illustrative embodiments of processing platforms will now be described in greater detail with reference to FIG. 10. Although described in the context of system 100, these platforms may also be used to implement at least portions of other information processing systems in other embodiments.

FIG. 10 shows aspects of a computing device or a computing system in accordance with example embodiments. The computer 1000 is shown in the form of a general-purpose computing device. Components of the computer may include, but are not limited to, one or more processors or processing units 1002, a memory 1004, a network interface 1006, and a bus 1016 that communicatively couples various system components including the system memory and the network interface to the processor.

The bus 1016 represents one or more of any of several types of bus structures, including a memory bus or memory controller, a peripheral bus, an accelerated graphics port, and a processor or local bus using any of a variety of bus architectures. By way of non-limiting example, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The computer 1000 typically includes a variety of computer-readable media. Such media may be any available media that is accessible by the computer system, and such media includes both volatile and non-volatile media, removable and non-removable media.

The memory 1004 may include computer system readable media in the form of volatile memory, such as random-access memory (RAM) and/or cache memory. The computer system may further include other removable/non-removable, volatile/non-volatile computer system storage media. By way of example only, the storage system 1010 may be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media may be provided. In such instances, each may be connected to the bus 1016 by one or more data media interfaces. As has been depicted and described above in connection with FIGS. 1-9, the memory may include at least one computer program product having a set (e.g., at least one) of program modules that are configured to carry out the functions of the embodiments as described herein.

The computer 1000 may also include a program/utility, having a set (at least one) of program modules, which may be stored in the memory 1004 by way of non-limiting example, as well as an operating system, one or more application programs, other program modules, and program data. Each of the operating system, one or more application programs, other program modules, and program data or some combination thereof, may include an implementation of a networking environment. The program modules generally carry out the functions and/or methodologies of the embodiments as described herein.

The computer 1000 may also communicate with one or more external devices 1012 such as a keyboard, a pointing device, a display 1014, etc.; one or more devices that enable a user to interact with the computer system; and/or any devices (e.g., network card, modem, etc.) that enable the computer system to communicate with one or more other computing devices. Such communication may occur via the Input/Output (I/O) interfaces 1008. Still yet, the computer system may communicate with one or more networks such as a local area network (LAN), a general wide area network (WAN), and/or a public network (e.g., the Internet) via the network adapter 1406. As depicted, the network adapter communicates with the other components of the computer system via the bus 1016. It should be understood that although not shown, other hardware and/or software components could be used in conjunction with the computer system. Non-limiting examples include microcode, device drivers, redundant processing units, external disk drive arrays, Redundant Array of Independent Disk (RAID) systems, tape drives, data archival storage systems, etc.

It is noted that embodiments of the invention, whether claimed or not, cannot be performed, practically or otherwise, in the mind of a human. Accordingly, nothing herein should be construed as teaching or suggesting that any aspect of any embodiment could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

While the invention has been described with respect to a limited number of embodiments, those of ordinary skill in the art, having the benefit of this disclosure, will appreciate that other embodiments can be devised that do not depart from the scope of the invention as disclosed herein. Accordingly, the scope of the invention should be limited only by the appended claims.

What is claimed is:

1. A system comprising:
at least one processing device including a processor coupled to a memory;
the at least one processing device being configured to implement the following steps:
detecting a drift period in a dataset, the drift period including a start time, wherein the dataset pertains to a machine learning (ML)-based model;
determining a first confidence value for a period preceding the start time and a second confidence value for a period following the start time; and
predicting a drift period duration for the dataset using an ML-based drift model that is trained based on the first and second confidence values.

2. The system of claim 1, wherein the first or second confidence value is determined for each class predicted by the ML-based model.

3. The system of claim 1,
wherein the dataset includes a plurality of samples collected from a plurality of data streams received by a plurality of nodes, and
wherein the detecting the drift period further comprises determining whether a confidence score for one or more samples among the plurality of samples exceeds a predetermined threshold.

4. The system of claim 3, wherein the detecting the drift period further comprises:
determining an end time for the drift period; and
determining whether the confidence score for the one or more samples exceeds the predetermined threshold at any time between the start time and the end time.

5. The system of claim 1, wherein the period preceding the start time is determined based on a measure of time associated with collecting a quantity of samples contained in the preceding period.

6. The system of claim 1, wherein the period preceding the start time corresponds to a measure of time associated with training and deploying an updated version of the ML-based model to a node.

7. The system of claim 1, wherein the ML-based model or the drift model is a classifier model or a regression model.

8. The system of claim 1, wherein the period preceding the start time immediately precedes the start time.

9. The system of claim 1, wherein the period following the start time immediately follows the start time.

10. The system of claim 1, wherein the period following the start time is shorter than the drift period duration.

11. A method comprising:
detecting a drift period in a dataset, the drift period including a start time, wherein the dataset pertains to a machine learning (ML)-based model;
determining a first confidence value for a period preceding the start time and a second confidence value for a period following the start time; and
predicting a drift period duration for the dataset using an ML-based drift model that is trained based on the first and second confidence values.

12. The method of claim 11, wherein the first or second confidence value is determined for each class predicted by the ML-based model.

13. The method of claim 11,
wherein the dataset includes a plurality of samples collected from a plurality of data streams received by a plurality of nodes, and
wherein the detecting the drift period further comprises determining whether a confidence score for one or more samples among the plurality of samples exceeds a predetermined threshold.

14. The method of claim 13, wherein the detecting the drift period further comprises:
determining an end time for the drift period; and
determining whether the confidence score for the one or more samples exceeds the predetermined threshold at any time between the start time and the end time.

15. The method of claim 11, wherein the period preceding the start time is determined based on a measure of time associated with collecting a quantity of samples contained in the preceding period.

16. The method of claim 11, wherein the period preceding the start time corresponds to a measure of time associated with training and deploying an updated version of the ML-based model to a node.

17. The method of claim 11, wherein the ML-based model or the drift model is a classifier model or a regression model.

18. The method of claim 11, wherein the period preceding the start time immediately precedes the start time, or wherein the period following the start time immediately follows the start time.

19. The method of claim 11, wherein the period following the start time is shorter than the drift period duration.

20. A non-transitory processor-readable storage medium having stored therein program code of one or more software programs, wherein the program code when executed by at least one processing device causes the at least one processing device to perform the following steps:
detecting a drift period in a dataset, the drift period including a start time, wherein the dataset pertains to a machine learning (ML)-based model;
determining a first confidence value for a period preceding the start time and a second confidence value for a period following the start time; and
predicting a drift period duration for the dataset using an ML-based drift model that is trained based on the first and second confidence values.
